(19) United States
(12) Patent Application Publication
(10) Pub. No.: US 2026/0227358 A1
(43) Pub. Date: Aug. 6, 2026

(54) CERAMIC PANEL, METHOD FOR PRODUCTION AND USES

(71) Applicants: CENTITVC - CENTRO DE NANOTECNOLOGIA E MATERIAIS TECNICOS FUNCIONAIS E INTELIGENTES, Vila Nova de Famalicão (PT); CENTRO TECNOLOGICO DA CERAMICA E DO VIDRO CTCV, Coimbra (PT); ALELUIA CERÂMICAS SA, Aveiro (PT); CONCEXEC - ARQUITETURA, LDA, Oliveira De Azeméis (PT)

(72) Inventors: Ana Inês BATISTA LOURENÇO RONDÃO, Coimbra (PT); Victor Manuel MENDES FRANCISCO, Coimbra (PT); António Geraldo DO BEM FERNANDES DE SOUSA LAMAS, Aveiro (PT); Paula Cristina COELHO ROSETE, Aveiro (PT); José ROSA SANTOS, Aveiro (PT); Jaime Alberto FERNANDES DA SILVA, Oliveira De Azeméis (PT); Ricardo MARTINS CAMPOS, Vila Nova de Famalicão (PT); Sarah BRITO BOGAS, Vila Nova de Famalicão (PT); Liliana Adelina AFONSO NOVO DE ALMEIDA TRUTA, Vila Nova de Famalicão (PT); lsaque Joaquim DE ARAÚJO SÁ, Vila Nova de Famalicão (PT)

(73) Assignees: CENTITVC - CENTRO DE NANOTECNOLOGIA E MATERIAIS TECNICOS FUNCIONAIS E INTELIGENTES, Vila Nova de Famalicão (PT); CENTRO TECNOLOGICO DA CERAMICA E DO VIDRO CTCV, Coimbra (PT); ALELUIA CERÂMICAS SA, Aveiro (PT); CONCEXEC - ARQUITETURA, LDA, Oliveira De Azeméis (PT)

(21) Appl. No.: 19/159,159

(22) PCT Filed: Feb. 21, 2024
(86) PCT No.: PCT/IB2024/051660

§ 371 Date: Aug. 22, 2025

(30) Foreign Application Priority Data
Feb. 22, 2023 (PT) 118527

(51) Int. Cl. G01N 27/12

(52) U.S. Cl. CPC G01N 27/127

(57) ABSTRACT

It is disclosed a ceramic panel in direct contact with a wall, comprising a support ceramic tile; at least one integrated gas sensor deposited over the visible surface of the support ceramic tile, at least one connection of the support ceramic tile to an electronic control unit in the back surface of the support ceramic tile, wherein the support ceramic tile comprises a percentage of water absorption lower than 0.03%, wherein the gas sensor comprises at least one sensitive layer on top of at least one conductive layer, wherein the conductive layer comprises at least one interdigitate electrode, wherein the sensitive layer comprises 25% to 50% (w/w) of a metal-oxide semiconductor nanoparticle dispersed in 50% to 75% (w/w) of a polymeric matrix, with the incorporation of 0.5 to 1% (w/w) of a dispersing agent with respect to the mixture of the metal-oxide semiconductor nanoparticle and the polymeric matrix.

### TECHNICAL FIELD

The present disclosure relates to a ceramic panel, a method for production and uses thereof; namely a ceramic panel comprising a gas sensor, preferably a ceramic tile.

### BACKGROUND

The use of advanced sensing techniques for detecting, indicating and monitoring gases, for example dangerous gases in industry, and the environment is very important for health and safety.

It is very important that precise and rapid detection, alerting, and monitoring of gases should be available to prevent or minimize accidents involving poisoning or explosions. For example, dangerous gases, such as carbon monoxide, carbon dioxide, hydrogen sulphide, chlorine, bromine, or others, are found in a wide variety of situations, varying from industry: chemical, heavy, petroleum, electronic, coal, gas, mines, to warehouses, enclosed parking areas, vehicles, sewerage, waste disposal, the atmosphere, houses, and even battle fields. In the past, certain colour changing reagents were adopted to detect these gases by tedious and time-consuming colorimetric, or more complicated chromatographic methods. However, in the last ten to twenty years techniques have progressed rapidly and more sensors have been developed for the fast precise detection of various dangerous gases. Four kinds of sensors are widely available, such as electrochemical, semiconductor, catalytic field effect and catalytic gas sensors.

Document US20210041387A1 discloses a C02 gas sensor based on carbon nanotubes (CNT). The disclosed structure is composed by a carbon nanotube film and an absorbing layer deposited over said CNT film. The ink formulation used is composed by branched polyethylenimine, polyethylene glycol, and poly[1-(4-vinylbenzyl)-3-methylimidazolium tetrafluoroborate] of the formula I:

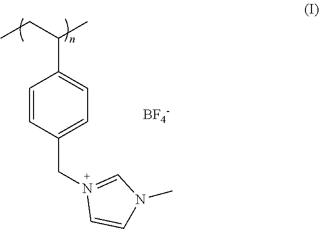

wherein n ranges from 10-300. Also in this document, it is described several procedure steps for the production of each sensing part, involving chemical products with significant toxicity and need for special handling conditions, which provides a high level of complexity for production process.

Document U.S. Ser. No. 11/275,051B2 discloses metal oxide-based chemical sensors that are integrated using a hybrid polycrystalline gas-sensitive material to create an uniform and integrated sensory system. It is disclosed a chemical sensor platform comprising an oxidized silicon membrane, which comprises a silicon (Si) layer and a silicon oxide (SiO2) layer. The disclosed sensors were studied specifically for a hydrogen sulphide (H2S) concentration range 100-500 ppm. The design helped to improve selectivity, sensitivity, faster response time and lower power consumption.

Document US20220178856A1 discloses a catalyst for a gas sensor and includes a support and a porous core-shell type complex contained in the support structure. The complex includes a gas sensor, manufactured in a micro electro-mechanical system (MEMS), that detects hydrogen and some variations, such as ethanol or formaldehyde, with a long sensor life and excellent durability. The support may be a ceramic containing a metal oxide and a carbon-based compound. This document does not refer or anticipate the detection of CO2 or the effect of the water vapor on its effectiveness.

A prefabricated modular construction technology is disclosed in several geographies, such as under document PT108880 in Portugal, document EP3361019 for the designated countries of the European Patent Convention, document U.S. Ser. No. 10/781,583B2 in the United States of America, document CN108138491A in China, document J/004556 in Macao, document HK1256559 in Hong Kong, document IN201847016871 in India, document PA92085 in Panama and document ZA2018/03016 in South Africa, where it is disclosed the technology of a fitting and locking profile for a prefabrication building system and assembly and disassembly process of a fitting profile system, having its application in the construction area by means of panels for the construction of all kinds of structures.

The prefabricated modular construction technology has homologation of the constructive system for the construction of buildings with an European Technical Assessment (ETA), an European homologation, being identified by “UnusHouse” and “CircularBuild”.

These facts are described in order to illustrate the technical problem solved by the achievements of the present document.

### General Description

The present disclosure relates to a ceramic panel, a method for production and uses thereof; namely a ceramic panel comprising a gas sensor, preferably a ceramic tile.

This disclosure relates to a ceramic panel comprising an integrated gas sensor for the detection of risk situation in home, namely the presence of gases, namely dangerous gases, wherein said gas sensor is deposited directly on the visible surface of a support ceramic tile. Said ceramic plate is used in direct contact with wall application. Said gas sensor comprises a sensitivity layer produced by deposition technologies, allowing a rapid, non-invasive, and innovative way to measure the quantity of gases, especially dangerous gases, and infers a possible fire in real time, in a non-intrusive way.

A method of production of the ceramic plate comprising the steps of depositing the gas sensor directly into the surface of the support ceramic tile as substrate, makes it possible to have a sensitive solution integrated and almost imperceptible to the user. The gas sensor comprises a chemiresistive-based mechanism, where a sensitivity layer can be deposited on top of at least one conductive layer that comprises at least one interdigitate electrode. The gas sensor is deposited, for example through inkjet, screen printing, spray coating, spin coating, doctor blade, drop casting, slot die or additive manufacturing techniques, on the visible surface of a support ceramic tile and the electronic board are placed on the back surface of the support ceramic tile, thus remaining invisible to the user. The metal-oxide semiconductor nanoparticle is dispersed in a polymeric matrix, with the incorporation of a dispersing agent. This optimized ink formulation allows to achieve a better dispersion and a higher number of adsorption sites for gas. The interdigitate electrode is the conductive layer for monitoring of signals from the sensor, namely the change in resistance caused by a chemical reaction, preferably the chemisorption on the sensitivity layer of the reactional products produced in the combustion reaction. The sensitive layer of the metal-oxide semiconductor strongly depends on the amount of oxygen species adsorbed on its surface, which means that when the metal-oxide semiconductor is exposed to air, oxygen molecules in the air get adsorbed on its surface in the form of chemisorbed oxygen species, such as O2-, O— and O2-, by trapping electrons from its conduction band. The adsorbed oxygen species induce, thus, an electron depletion region in the semiconductor thereby reducing the carrier concentration. This phenomenon has a directly influence in the adsorption of some gas molecules, for example, CO2, because higher number of oxygen adsorption results in high adsorption of gas molecules on the metal-oxide semiconductor surface. The metal-oxide semiconductor, which in an embodiment can be tin oxide, comprises a porous structure that favors the diffusion and transport of a target gas in and out of the sensitive layer.

The now disclosed gas sensor embedded into the ceramic panel does not need any preliminary activation, such as an activation using Ultraviolet-light.

Additionally, to improve the sensors' durability to usage conditions, a polymeric-based encapsulation membrane could be applied to overlap the sensor.

In an embodiment, the polymeric-based encapsulation membrane is porous, hydrophobic, and chemically and mechanically resistant to external agents, such as detergents. In an embodiment, the material of the polymeric-based encapsulation membrane may be selected from a list consisting of polyethylene, polyvinylidene fluoride-trifluoroethylene, polytetrafluoroethylene, polycarbonate, polyester, or their combinations.

In an embodiment, the polymeric-based encapsulation membrane comprises a porous surface with a diameter between 0.5 and 25 μm, more preferably between 3 and 15 μm. The porosity may be calculated by the methods of microscopy techniques using SEM or AFM, by physical adsorption of a gas using BET analysis, by mercury porosimetry or helium pycnometry.

In an embodiment, the polymeric-based encapsulation membrane protects the said sensor while cleaning. Different cleaning processes were tested, cleaning with a soft dry cloth, with water and water with degreasing liquid. Cyclic events of cleaning and activation of the sensor had been realized and showed the reproducibility of the sensor.

The disclosed gas sensor can be connected with an electronic control system that is made by using a printed circuit board (PCB). The developed electronic board can be integrated and fixed on modular constructive panel cavities.

In an embodiment, the PCB part comprises a dimension lower than 10 cm length×10 cm width cm×2.5 cm thickness, preferably less than 6 cm×6 cm×1.5 cm each side (square).

The prefabricated modular constructive technology allows the integration of sensing technology in the built environments, as well as the integration of equipment inherent to its proper functioning, through coatings and materials associated with monitoring and sensing of spaces, namely wood-based materials, as well as ceramic coating materials, facilitated by the flexibility and evolutionary capacity of the constructive system, through the optimization of the entire production process and detailed planning in the production of panels in an industrial environment.

All the panels produced in the constructive technology present a standardized form, through the machining of all its components. All wall and floor/roof panels are previously machined, having paths/negatives for the integration of vertical and horizontal infrastructures along the entire length of the panel, functionally interconnected among themselves. Through planning, it is possible in advance to create negatives directed and necessary for the integration of specific infrastructures, which require different configurations and dimensions, already in the industrial process, thus avoiding the need for additional construction/deconstruction work in the assembly of the construction system on site.

The composition of the constructive technology and its technical, structural, mechanical and functional characteristics, allow the integration of the ceramic and wood covering materials on the surface, as well as the sensing systems, monitoring and auxiliary equipment inside, through the negatives, intended for the integration of infrastructures and equipment for feeding and distributing the necessary cabling for the proper functioning of the products developed.

With the prefabricated modular constructive technology, it is possible to speed up the whole process, reflecting the integration of infrastructures in an industrial and controlled environment, thus mitigating the error and waste, enhancing the perfect integration of infrastructures ensuring in the lifetime of the buildings, if necessary, any changes, developments, maintenance or disassembly to move the complete building or part of it.

These features give the constructive system evolutionary capacity, allowing the change of constructions according to user needs. Noteworthy that this evolutionary feature in line with the process of assembly and disassembly on site, can be programmed already in the design phase and in the planning of the production of panels, allowing the expansion or reduction of construction, as well as the continuity of infrastructures according to the future configuration.

The constructive system allows the maintenance of the sensing and monitoring systems, in space and time, through the replacement of sensors, cabling or power supply equipment, reception and communication of information according to the needs of the built space.

All the described characteristics are aligned with the principles of the circular economy and zero waste policy.

The application of the ceramic panel, that is on the main group of the sensitive ceramics, avoids the need to have additional equipment such as gas detectors, that are often installed in a post-construction phase, much more intrusive and not visually suiting the environment in which they are integrated.

In an embodiment, the gas sensor is deposited on the visible surface of the support ceramic tile using deposition technology and the connection of said ceramic panel to the control electronic unit is made through a flat cable, a printed track, an electric wire, or any other suitable connection mode or their combinations thereof, connected to the back surface of the support ceramic tile, where it is placed in order to be imperceptible.

The ceramic panel can be applied on walls, making the inhabited space safer, in a non-intrusive way, and well-integrated into the interior decoration. These ceramic panels comprising deposited gas sensors directly in ceramic materials turn these products into a new device that interacts with the environment, where they are integrated, ceasing to be no longer just passive wall coverings, but acquiring a fundamental role in the security of those environments.

Furthermore, given the concerns inherent to the integration of this solution in construction systems, namely the need for maintenance of the sensors, which may require access to the power supply, electronic board and electric wiring located in the back of the products, this ceramic panel can comprise a specific fixing to adhere the ceramic panel to the base constructive system. This fixing system allows the ceramic to be fixed to the wall in a non-permanent way, as achieved with conventional mortars, allowing an easy non-destructive removal in case of need of access to the control system of the sensor. At the same time, it allows preserving the electronic components, which do not come in contact with conventional mortars, which would also adhere to them, and therefore make impossible their removal and/or reuse after a potential failure.

In the development of this new product the aim was to develop a ceramic panel that comprises a rapid, non-invasive, and innovative gas sensor for the detection of leakage of gases, preferably dangerous gases, and infer possible fire and/or toxic atmospheres in real time.

This fully sensing solution can be developed in modular constructive houses aimed monitoring and warning danger situations to improve life quality and autonomy of users. For that, the ceramic panel includes a gas sensor located/placed in direct contact with air, which can have an additional encapsulation of the sensitive layer for protection against external agents, such as detergents.

One aspect of the present disclosure is a ceramic panel in direct contact with a wall, comprising: a support ceramic tile; at least one integrated gas sensor deposited over the visible surface of the support ceramic tile, at least one connection of the support ceramic tile to a control electronic unit in the back surface of the support ceramic tile, wherein the support ceramic tile comprises a percentage of water absorption lower than 0.03%, wherein the gas sensor comprises at least one sensitive layer on top of at least one conductive layer, wherein the conductive layer comprises at least one interdigitate electrode, wherein the sensitive layer comprises 25% to 50% (w/w) of a metal-oxide semiconductor nanoparticle dispersed in 50% to 75% (w/w) of a polymeric matrix, with the incorporation of 0.5 to 1% (w/w) of a dispersing agent with respect to the mixture of the metal-oxide semiconductor nanoparticle and the polymeric matrix.

The ceramic panel of the present disclosure surprisingly allow a better and easier detection of a gas presence directly on the integrated gas sensor deposited over the visible surface of a support ceramic tile, without the need of any kind of encapsulation. Nevertheless, even in the case where the gas sensor comprises a protective encapsulation layer against external agents, surprisingly there is still a very accurate reading. Even more surprisingly, the now disclosed ceramic panel does not need any preliminary activation, such as an activation using Ultraviolet-light, for the detection of a gas.

In an embodiment, the connection to the electronic control unit of the ceramic panel is selected from a list consisting of a flat cable, a printed track, an electric wire, an electronic component, or their combinations thereof.

In an embodiment, the ceramic panel comprises a fixing system.

In an embodiment, the fixing system of the ceramic panel comprises a fastener.

In an embodiment, the dispersing agent used in the gas sensor used in the ceramic panel is selected from a list consisting of a modified styrene maleic acid, poly(acrylic acid-co-maleic acid), poly(acrylic acid-co-hydroxyethyl methacrylate), polyoxyethylene sorbitan monooleate or their combinations thereof.

In an embodiment, the sensitivity layer of the gas sensor used in the ceramic panel according to any of the previous claims, wherein comprises 25% to 33% (w/w) of the metal-oxide semiconductor nanoparticle, 67% to 75% (w/w) of the polymeric matrix and 0.5 to 1% (w/w) of the dispersing agent with respect to the mixture of the metal-oxide semiconductor nanoparticle and the polymeric matrix.

In an embodiment, the metal-oxide semiconductor nanoparticle used in the gas sensor of the ceramic panel is selected from a list consisting of: titanium oxide, zinc oxide, bismuth oxide, tin oxide, or their combinations thereof.

In an embodiment, the material of the polymeric matrix in the gas sensor of the ceramic panel is selected from a list consisting of: carboxymethyl cellulose, hydroxyethyl cellulose, aliphatic polyester polyurethane, or their combinations thereof.

In an embodiment, the metal-oxide semiconductor nanoparticle used in the gas sensor of the ceramic panel is tin oxide.

In an embodiment, the material of the polymeric matrix used in the gas sensor of the ceramic panel is aliphatic polyester polyurethane.

In an embodiment, the particle diameter of the metal-oxide semiconductor nanoparticle in the gas sensor of the ceramic panel is below 100 nm, preferably from 10 to 100 nm, more preferably from 15 to 90 nm and even more preferably from 20 to 80 nm.

In an embodiment, the metal-oxide semiconductor nanoparticle of the gas sensor in the ceramic panel comprises a size distribution with a D50 from 50 to 250 nm, preferably from 50 to 100 nm and a D90 from 10 to 500 nm, preferably from 30 to 300 nm.

The measurement of the particle size and its distribution can be accessed by laser diffraction analysis, dynamic light scattering (DLS) analysis, scanning electron microscopy (SEM), transmission electron microscopy (TEM) or by using the standard method ASTM D6128-16-2016: Standard Test Method For Shear Testing Of Bulk Solids Using The Jenike Shear Tester, for a more precise analysis.

It is also disclosed the use of the ceramic panel in a construction building, preferably a modular constructive panel.

It is also disclosed a method for production of the ceramic panel comprising the following steps: preparing an ink for deposition of the sensitive layer; deposition process of a conductive layer in the surface of a support ceramic tile; deposition process of a sensitive layer on top of the conductive layer; curing process.

In an embodiment, the step of preparing the ink for deposition in the method in comprises the following steps: dispersing the metal-oxide semiconductor nanoparticles in the polymeric matrix until complete homogenization; incorporating the dispersing agent; curing process.

In an embodiment, the dispersion of the metal-oxide semiconductor nanoparticles in the polymeric matrix in the above mentioned method is produced using a device for mix or stir liquid solutions with a rotation comprised from 200 to 350 rpm at a temperature range of 20 to 30° C. for 2 to 3 hours.

In an embodiment, the device for mix or stir liquid solutions used in the method is selected from a list consisting of a stirrer plate, a magnetic stir bar and a magnetic stir bar retriever, an overhead stirrer and stirrer shaft, a vortex mixer, shaking incubator, or their combinations.

In an embodiment, the rotation of the device for mix or stir liquid solutions used in the method is comprised from 220 to 300 rpm, preferably from 240 to 270 rpm.

In an embodiment, the temperature range of the device for mix or stir liquid solutions used in the method is comprised from 22° C. to 27° C., preferably from 22° C. to 24° C.

In an embodiment, the deposition process of the method is selected from a list consisting of: inkjet, screen printing, spray coating, spin coating, doctor blade, drop casting, slot die, additive manufacturing techniques or their combinations thereof.

In an embodiment, the curing process of the method is performed at a temperature comprised from 80° C. to 150° C. during 5 to 10 minutes.

### BRIEF DESCRIPTION OF THE DRAWINGS

The following figures provide preferred embodiments for illustrating the disclosure and should not be seen as limiting the scope of invention.

FIG. 1: Schematic representation of an embodiment of the ceramic panel.

FIG. 2: Schematic representation of an embodiment of the gas sensor with the polymeric based membrane.

FIG. 3: Graphic representation of the variation of the sensor resistance in an environment where it has been added CO₂ and CO₂+H₂O and the comparison with the usual behavior of a gas sensor from the prior art. The gas sensor is not incorporated with a porous polymeric-based encapsulation membrane.

FIG. 4: Graphic representation of the variation of the sensor resistance in an environment where it has been added CO₂+H₂O and the comparison with the usual behavior of a gas sensor from the prior art. The gas sensor is not incorporated with a porous polymeric-based encapsulation membrane.

FIG. 5: Graphic representation of the variation of the sensor resistance with the variation of the CO₂+H₂O rate with two cycles in an environment. The gas sensor is not incorporated with a porous polymeric based membrane.

FIG. 6: Graphic representation of the variation of the sensor resistance with the variation of the CO₂+H₂O rate with multiple cleaning cycles: dry, with water and with water and degreasing cleaning. The gas sensor is incorporated with a porous polymeric based membrane.

Throughout the figures indicated above, the following elements are indicated with the respective references:
1—sensitive layer;
2—substrate;
3—conductive layer;
4—polymeric-based encapsulation membrane.

### DETAILED DESCRIPTION

The present disclosure relates to a ceramic panel, a method for production and uses thereof; namely a ceramic panel comprising a gas sensor, preferably a ceramic tile.

In an embodiment, the production of the ceramic panel involves a printing process, by screen printing on the ceramic material, of the electronic circuit and sensitive layer and its connections to the back of the ceramic piece. The support ceramic tile comprises a very low porosity, i.e. considering a percentage of water absorption lower than 0.03%, preferably from 0.01 to 0.03%, even more preferably from 0.015 to 0.025%. As result, there is no need for any pre-treatment on the ceramic to print the sensors. The sensor comprises at least two deposited electrodes in an interdigitated design, being a conductive layer made of silver, copper, or other metallic elements, or combinations thereof. The sensitive layer printed on top of the conductive layer acts as a gas detector. The curing process is performed at a temperature comprised from 80° C. to 150° C. during 5 to 10 minutes.

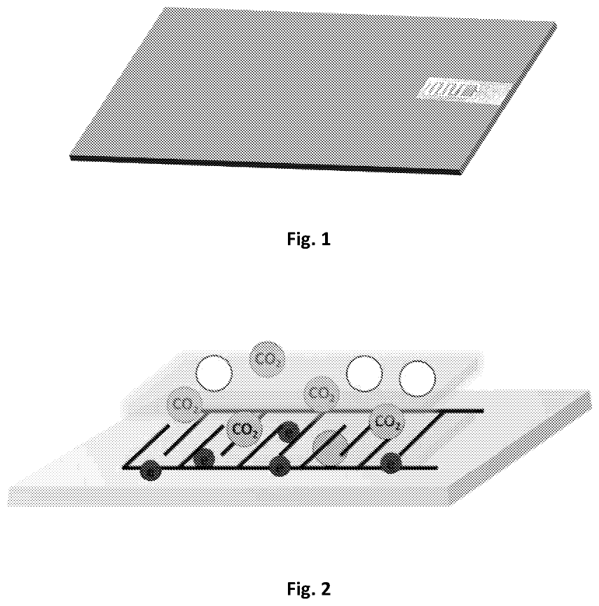

In an embodiment, illustrated in FIG. 2, the gas sensor now disclosed comprises at least one sensitive layer (1) on top of at least one conductive layer (3), wherein the conductive layer (3) comprises at least one interdigitate electrode, wherein the sensitive layer (1) comprises 25% to 50% (w/w) of a metal-oxide semiconductor nanoparticle dispersed in 50% to 75% (w/w) of a polymeric matrix, with the incorporation of up to 1% (w/w) of a dispersing agent with respect to the mixture of the metal-oxide semiconductor nanoparticle and polymeric matrix; and a ceramic substrate (2) to support the conductive layer (3), overlapped by a porous polymeric based membrane (4).

In an embodiment, for maintenance purposes, the ceramic panel comprises a fixing system that allows easy, non-destructive removal of the ceramic material, as an alternative to the mortars traditionally used in construction. In an embodiment, the fixing system comprises a fastener, such as Velcro, with 0.08 N/mm2 of tensile adhesion strength, well below the required for a conventional mortar, i.e. >0.5 N/mm2, but enough to ensure the fixation of the component, which allows the disassembly of the piece in case of need of maintenance due to the breakdown of electric or electronic components. This technology leads to a solution that is almost-invisible, non-intrusive and easy to install and remove.

In an embodiment, the modular constructive system comprises pre-existing cavities that will accommodate the electronic board (PCB) of the sensor, allowing the achievement of made a non-invasive solution for the users.

It is disclosed a ceramic panel in direct contact with a wall, comprising a support ceramic tile; at least one integrated gas sensor deposited over the visible surface of the support ceramic tile, at least one connection of the support ceramic tile to a control electronic unit in the back surface of the support ceramic tile, wherein the support ceramic tile comprises a percentage of water absorption lower than 0.03%, wherein the gas sensor comprises at least one sensitive layer on top of at least one conductive layer, wherein the conductive layer comprises at least one interdigitate electrode, wherein the sensitive layer comprises 25% to 50% (w/w) of a metal-oxide semiconductor nanoparticle dispersed in 50% to 75% (w/w) of a polymeric matrix, with the incorporation of up to 1% (w/w) of a dispersing agent with respect to the mixture of the metal-oxide semiconductor nanoparticle and the polymeric matrix.

In an embodiment, the connection to the electronic control unit of the ceramic panel is selected from a list consisting of a flat cable, a printed track, an electric wire, an electronic component or their combinations thereof, for better data transmission.

In an embodiment, the ceramic panel comprises a fixing system, for better fixation of the ceramic panel.

In an embodiment, the fixing system of the ceramic panel comprises a fastener for easier fixation of the ceramic panel without compromise the fixation process.

In an embodiment, the dispersing agent used in the gas sensor used in the ceramic panel is selected from a list consisting of a modified styrene maleic acid, poly(acrylic acid-co-maleic acid), poly(acrylic acid-co-hydroxyethyl methacrylate), polyoxyethylene sorbitan monooleate or their combinations thereof, for better results.

In an embodiment, the sensitive layer of the gas sensor used in the ceramic panel according to any of the previous claims, wherein comprises 25% to 33% (w/w) of the metal-oxide semiconductor nanoparticle, 67% to 75% (w/w) of the polymeric matrix and 0.5 to 1% (w/w) of the dispersing agent with respect to the mixture of the metal-oxide semiconductor nanoparticle and the polymeric matrix, for better results.

In an embodiment, the metal-oxide semiconductor nanoparticle used in the gas sensor of the ceramic panel is selected from a list consisting of: titanium oxide, zinc oxide, bismuth oxide, tin oxide, or their combinations thereof, for better results.

In an embodiment, the material of the polymeric matrix in the gas sensor of the ceramic panel is selected from a list consisting of: carboxymethyl cellulose, hydroxyethyl cellulose, aliphatic polyester polyurethane, or their combinations thereof, for better results.

In an embodiment, the metal-oxide semiconductor nanoparticle used in the gas sensor of the ceramic panel is tin oxide, for better results.

In an embodiment, the material of the polymeric matrix used in the gas sensor of the ceramic panel is aliphatic polyester polyurethane, for better results.

In an embodiment, the particle diameter of the metal-oxide semiconductor nanoparticle in the gas sensor of the ceramic panel is below 100 nm, preferably from 10 to 100 nm, more preferably from 15 to 90 nm and even more preferably from 20 to 80 nm, for better results.

In an embodiment, the metal-oxide semiconductor nanoparticle of the gas sensor in the ceramic panel comprises a size distribution with a D50 from 50 to 250 nm, preferably from 50 to 100 nm and a D90 from 10 to 500 nm, preferably from 30 to 300 nm, for better results.

The measurement of the particle size and its distribution can be accessed by laser diffraction analysis, dynamic light scattering (DLS) analysis, scanning electron microscopy (SEM), transmission electron microscopy (TEM) or by using the standard method ASTM D6128-16-2016: Standard Test Method For Shear Testing Of Bulk Solids Using The Jenike Shear Tester, for a more precise analysis.

In an embodiment, the gas sensor of the ceramic panel further comprises a polymeric-based encapsulation membrane, for better results and higher resistance against external agents.

In an embodiment, the polymeric-based encapsulation membrane of the gas sensor comprises a porous surface with a diameter between 0.5 and 25 μm, more preferably between 3 and 15 μm, for better and more accurate results.

In an embodiment, the material of the polymeric-based encapsulation membrane of the gas sensor is selected from a list consisting of polyethylene, polyvinylidene fluoride-trifluoroethylene, polytetrafluoroethylene, polycarbonate, polyester, or their combinations, for better results.

It is also disclosed the use of the ceramic panel in a construction building, preferably a modular constructive panel.

It is also disclosed a method for production of the ceramic panel comprising the following steps: preparing an ink for deposition of the sensitive layer; deposition process of a conductive layer in the surface of a support ceramic tile; deposition process of a sensitive layer on top of the conductive layer; curing process.

In an embodiment, the step of preparing the ink for deposition in the method comprises the following steps: dispersing the metal-oxide semiconductor nanoparticles in the polymeric matrix until complete homogenization; incorporating the dispersing agent; curing process, for better results.

In an embodiment, the dispersion of the metal-oxide semiconductor nanoparticles in the polymeric matrix in the above-mentioned method is produced using a device for mix or stir liquid solutions with a rotation comprised from 200 to 350 rpm at a temperature range of 20 to 30° C. for 2 to 3 hours, for better results.

In an embodiment, the device for mix or stir liquid solutions used in the method is selected from a list consisting of a stirrer plate, a magnetic stir bar and a magnetic stir bar retriever, an overhead stirrer and stirrer shaft, a vortex mixer, shaking incubator, or their combinations, for better results.

In an embodiment, the rotation of the device for mix or stir liquid solutions used in the method is comprised from 220 to 300 rpm, preferably from 240 to 270 rpm, for better results.

In an embodiment, the temperature range of the device for mix or stir liquid solutions used in the method is comprised from 22° C. to 27° C., preferably from 22° C. to 24° C., for better results.

In an embodiment, the deposition process of the method is selected from a list consisting of: inkjet, screen printing, spray coating, spin coating, doctor blade, drop casting, slot die, additive manufacturing techniques or their combinations thereof, for better results.

In an embodiment, the curing process of the method is performed at a temperature comprised from 80° C. to 150° C. during 5 to 10 minutes, for better results.

In an embodiment, the method further comprises a step of encapsulation of the gas sensor by applying a polymeric-based encapsulation membrane, for better results and higher resistance against external agents.

Fourier-transform infrared (FT-IR) spectroscopy analysis was performed to evaluate the structural characterization of the ink. The FTIR spectra was obtained between 4000-700 cm-1, using 16 scans per measurement at a resolution of 8 cm-1 with the equipment PerkinElmer Spectrum 100. The equipment was equipped with an Attenuated Total Reflectance (ATR) accessory of diamond crystal. The films of sensitive layer spectra were collected under room temperature (22° C.)/humidity control (50%) after background correction.

The morphological characterization of the thin films of sensitive layer was performed by Ultra-high-resolution field-emission Scanning Electron Microscopy (FEI Nova 200 and Pegasus X4M form) with integrated microanalysis X-ray system (EDS—energy dispersive spectrometer) and Electron Backscatter Diffraction (EBSD). The images were obtained with a tension of 10 kV. The X-ray spectroscopy (XRD) analysis was performed to evaluate the differences in the crystal lattices of the metal-oxide semiconductor nanoparticle in the polymeric dispersion. The X-ray spectra was obtained by Bruker D8 with Cu-Kα radiation from 10° to 90°, with a step of 0.02 s and an exposition time of 1 s/step.

For these tests, it was used an embodiment using tin oxide as metal-oxide semiconductor nanoparticle, where it was very clear that there were no changes in crystal lattices of the tix oxide dispersed in polymeric matrix.

It was also very clear that with the presence of the dispersing agent, the metal-oxide semiconductor nanoparticle has a reduced diameter that promote the highest adsorption sites for gas.

The gas characterization of the sensor was evaluated by placing the sensor inside a testing chamber, adding a controlled gas flux, at a rate of 0.2 L/min, and at constant pressure of 0.8 Pa.

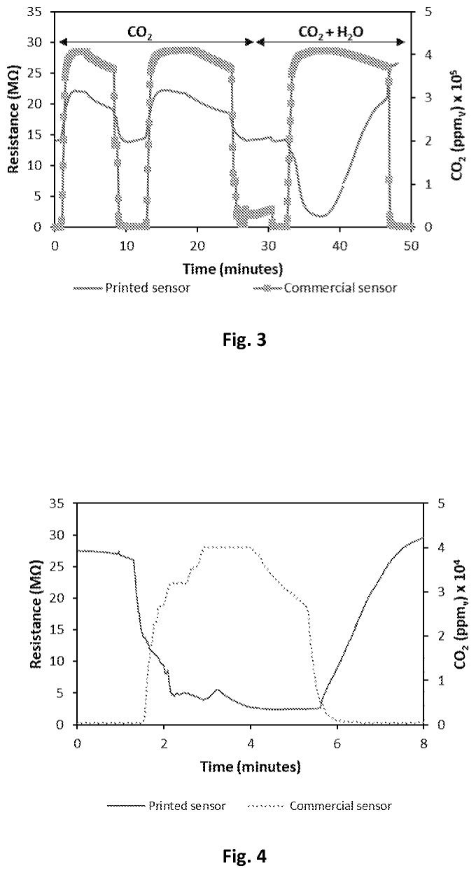

The tested gas sensor was placed in different locations inside of the chamber, and the variation of the resistance of the gas sensor with concentration of the gas is followed, on time, outside the chamber. All experiments were performed at room temperature. As can be seen on FIGS. 3, 4, and 5, positive and negative variations of resistance were achieved with the increase of gas mixture, CO₂, and CO₂+H₂O. The gas sensor detects CO₂ values up to 4×10¹ ppm, in the test chamber.

The tested gas sensor was not affected by relative humidity in the range 20% to 80% of relative humidity.

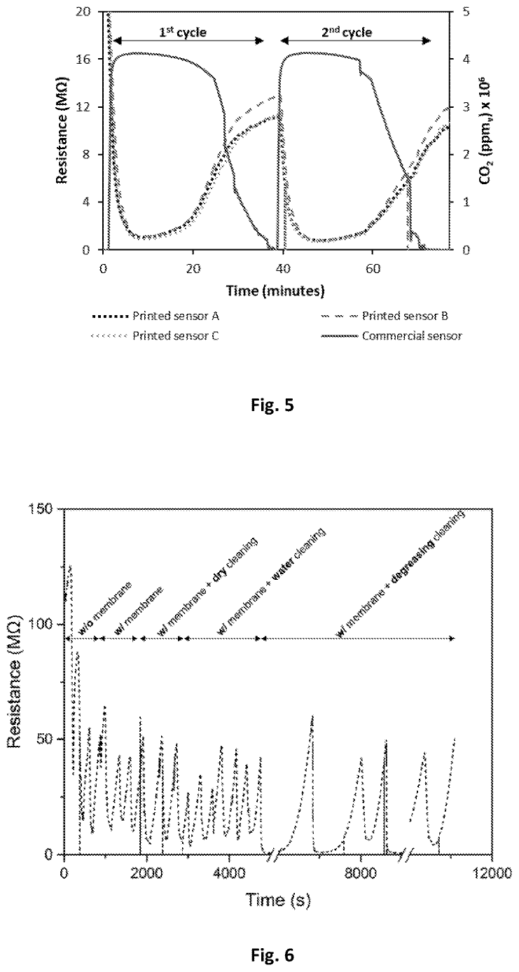

As can be seen in FIG. 5, the tested gas sensors present a cyclic behavior with the same variations in resistance.

This work was co-financed by the Operational Program for Competitiveness and Internationalization (COMPETE 2020), under the PORTUGAL 2020 Partnership Agreement, through the European Regional Development Fund (ERDF).

The term “comprising” whenever used in this document is intended to indicate the presence of stated features, integers, steps, components, but not to preclude the presence or addition of one or more other features, integers, steps, components or groups thereof.

The disclosure should not be seen in any way restricted to the embodiments described and a person with ordinary skill in the art will foresee many possibilities to modifications thereof.

The above-described embodiments are combinable.

The following claims further set out particular embodiments of the disclosure.

1. A ceramic panel in direct contact with a wall, comprising:
a support ceramic tile;
at least one integrated gas sensor deposited over the visible surface of the support ceramic tile; and
at least one connection of the support ceramic tile to an electronic control unit in the back surface of the support ceramic tile,
wherein the support ceramic tile comprises a percentage of water absorption lower than 0.03%,
wherein the gas sensor comprises at least one sensitive layer on top of at least one conductive layer,
wherein the at least one conductive layer comprises at least one interdigitate electrode, and
wherein the sensitivity layer comprises 25% to 50% (w/w) of a metal-oxide semiconductor nanoparticle dispersed in 50% to 75% (w/w) of a polymeric matrix, with the incorporation of 0.5 to 1% (w/w) of a dispersing agent with respect to the mixture of the metal-oxide semiconductor nanoparticle and the polymeric matrix.

2. The ceramic panel according to claim 1, wherein the connection to the electronic control unit is selected from the group consisting of: a flat cable, a printed track, an electric wire, an electronic component, and combinations thereof.

3. The ceramic panel according to claim 1, further comprising a fastener as a fixation system.

4. (canceled)

5. The ceramic panel according to claim 1, wherein the dispersing agent used in the gas sensor is selected from the group consisting of: a modified styrene maleic acid, poly(acrylic acid-co-maleic acid), poly(acrylic acid-co-hydroxyethyl methacrylate), polyoxyethylene sorbitan monooleate, and combinations thereof.

6. The ceramic panel according to claim 1, wherein the sensitive layer of the gas sensor comprises 25% to 33% (w/w) of the metal-oxide semiconductor nanoparticle, 67% to 75% (w/w) of the polymeric matrix and 0.5 to 1% (w/w) of the dispersing agent with respect to the mixture of the metal-oxide semiconductor nanoparticle and the polymeric matrix.

7. The ceramic panel according to claim 1, wherein the metal-oxide semiconductor nanoparticle in the gas sensor is selected from the group consisting of: titanium oxide, zinc oxide, bismuth oxide, tin oxide, and combinations thereof.

8. The ceramic panel according to claim 1, wherein the material of the polymeric matrix in the gas sensor is selected from the group consisting of: carboxymethyl cellulose, hydroxyethyl cellulose, aliphatic polyester polyurethane, and combinations thereof.

9. (canceled)

10. (canceled)

11. The ceramic panel according to claim 1, wherein the particle diameter of metal-oxide semiconductor nanoparticle in the gas sensor is below 100 nm.

12. The ceramic panel according to claim 1, wherein the metal-oxide semiconductor nanoparticle in the gas sensor comprises a size distribution with a D50 from 50 nm to 250 nm.

13. The ceramic panel according to claim 1, wherein the gas sensor further comprising a polymeric-based encapsulation membrane.

14. The ceramic panel according to claim 1, wherein the polymeric-based encapsulation membrane comprises a porous surface with a diameter between 0.5 and 25 μm, more preferably between 3 and 15 μm.

15. (canceled)

16. (canceled)

17. A method for production of the ceramic panel of claim 1, comprising the steps of:
preparing an ink for deposition of the at least one sensitive layer;
depositing the at least one conductive layer in the surface of the support ceramic tile;
depositing at least one of the sensitive layers on top of the conductive layer;
curing the layers.

18. The method according to claim 17, wherein the step of preparing the ink for deposition comprises:
dispersing the metal-oxide semiconductor nanoparticles in the polymeric matrix until complete homogenization;
incorporating the dispersing agent;
curing the ink with the dispersed metal-oxide semiconductor nanoparticles and the dispersing agent process.

19. The method according to claim 18, wherein the dispersion of the metal-oxide semiconductor nanoparticles in the polymeric matrix is produced using a device that mixes or stirs liquid solutions with a rotation in a range from 200 to 350 rpm at a temperature range of 20 to 30° C. for 2 to 3 hours.

20. The method according to any of the claim 19, wherein the device that mixes or stirs liquid solutions is selected from a list consisting of: a stirrer plate, a magnetic stir bar and a magnetic stir bar retriever, an overhead stirrer and stirrer shaft, a vortex mixer, shaking incubator, and combinations thereof.

21. The method according to claim 19 wherein the rotation of the device that mixes or stirs liquid solutions is in a range from 220 to 300 rpm.

22. The method according to claim 19, wherein the temperature range of the device that mixes or stirs liquid solutions is in a range from 22° C. to 27° C.

23. The method according to claim 17, 22, wherein the steps of depositing is selected from the group consisting of: inkjet, screen printing, spray coating, spin coating, doctor blade, drop casting, slot die, additive manufacturing techniques and combinations thereof.

24. The method according to claim 17, wherein the curing process is performed at a temperature in a range from 80° C. to 150° C. for 5 to 10 minutes.

25. The method according to claim 17, further comprising encapsulating the gas sensor by applying a polymeric-based encapsulation membrane.
